(19) United States
(12) Patent Application Publication
(10) Pub. No.: US 2008/0173071 A1
(43) Pub. Date: Jul. 24, 2008

(54) Honeycomb filter defect detecting method

(76) Inventors: Timothy A. Park, Corning, NY (US); Michael George Shultz, Big Flats, NY (US); David John Worthey, Elmira, NY (US)

Correspondence Address: CORNING INCORPORATED, SP-TI-3-1, CORNING, NY, 14831, US

(21) Appl. No.: 11/656,186

(22) Filed: Jan. 22, 2007

(51) Int. Cl. G01N 15/08

(52) U.S. Cl. 73/38

(57) ABSTRACT

A method for detecting defects in a honeycomb filter body. In operation, a gas flow stream containing particulates emerges at an outlet end face of the honeycomb body through defects, if any, in the honeycomb walls and/or plugs where they are illuminated. The gas flow stream containing the particles are provided at varying flow rates, pressures and particle densities during the course of the test cycle, thereby improving the signal-to-noise ratio, and reducing turbulence within the gas flow stream such that any defects within the filter body may be more readily detected.

### FIELD OF THE INVENTION

The invention relates generally to apparatus and test methods for detecting defects in articles. More specifically, the invention relates to a method and apparatus for detecting defects in a honeycomb particulate filters.

### BACKGROUND OF THE INVENTION

Honeycomb structures having traverse cross-sectional cellular densities of approximately one tenth to one hundred or more per square centimeter have several uses, including solid particulate filter bodies and stationary heat exchangers. The manufacture of these honeycomb structures from plasticized powder batches comprising inorganic powders dispersed in appropriate binders is well known. U.S. Pat. Nos. 3,790,654; 3,885,977; and 3,905,743 describe extrusion dies, processes, and compositions for such manufacture, while U.S. Pat. Nos. 4,992,233 and 5,011,529 describe honeycombs of similar cellular structure extruded from batches incorporating metal powders.

As an example, reference numeral 10 (FIG. 1) generally designates a prior art, solid particulate filter body that is generally well known and that may be tested utilizing a method as described below. The filter body includes a honeycomb structure 12 formed by a matrix of intersecting, thin, porous walls 14 surrounded by an outer wall 15, which in the illustrated example is provided a circular cross-sectional configuration. The walls 14 extend across and between a first end 13 that includes a first end face 18, and a second end 17 that includes an imposing second end face 20, and form a large number of adjoining hollow passages or cell channels 22 which also extend between and are open at the end faces 18, 20 of the filter body 10. To form the filter 10 (FIGS. 2 and 3), one end of each of the cells 22 is sealed, a first subset 24 of the cells 22 being sealed at the first end face 18, and a second subset 26 of the cells being sealed at the second end face 20. Either of the end faces 18, 20 may be utilized as the inlet face of the resulting filter 10. In a typical cell structure, each inlet cell channel is bordered on one or more sides by outlet cell channels, and vice versa. Each cell channel 22 may have a square cross section or may have other cell geometry, e.g., circular, rectangular, triangle, hexagon, octagon, etc. Diesel particulate filters are typically made of ceramic materials, such as cordierite, aluminum titanate, mullite or silicon carbide.

When particulates, such as soot found in exhaust gas, flow through the intersecting porous walls 14 of the honeycomb filter 10, a portion of the particulates in the fluid flow stream is retained on or in the intersecting porous wall 14. The efficiency of the honeycomb filter 10 is related to the effectiveness of the porous walls 14 in the filtering particulates from the fluid. Filtration efficiencies in excess of 80% by weight of the particulates may be achieved with honeycomb filters. However, filtration efficiencies or integrity of a honeycomb filter can be compromised by various defects, such as holes or cracks (such as fissures) and the like in the walls or plugs located within the end of the channels. Such defects allow the fluid to pass through the filter without proper filtration. Thus, in the manufacture of honeycomb filters, it is desirable to test the honeycomb filters for the presence of such defects that may affect filtration efficiency or integrity. In certain situations, the honeycomb filters with detected defects may be repaired, or if irreparable, discarded.

One such method and apparatus for detecting defects is described in co-pending U.S. Provisional Application No. 60/704,171, filed Jul. 29, 2005, and entitled METHOD AND APPARATUS FOR DETECTING DEFECTS IN A HONEYCOMB BODY USING A PARTICULATE FLUID. This method of detecting defects involves generating a fog and directing it at an inlet end face of the filter, such that the fog enters the filter. Cells having defects in the walls or plugs readily allow the fog to flow into the adjacent cells or through the defective plugs. Thus, larger amounts of fog emerge at the outlet end face of the honeycomb filter from any such defective cell/plug as compared to other portions of the filter. A light source, such as a laser source, is positioned to emit a planter sheet of light slightly above the outlet end face of the filter to irradiate the fog emerging therefrom. An imaging camera is preferably installed above the filter to photograph the image generated by the light plane intersecting with the fog. Brighter spots correspond to cells/plugs containing defects. Once identified, cells/plugs corresponding with the spots may be repaired.

One problem that is encountered during filter testing is that the background or noise level of the fog exiting the filter can be so high as to obfuscate the images of the defective cells. This is particularly true when the filter is exposed to the fog for a long period of time, so as to become saturated. Thus, there is a need for a method to further enhance the signal-to-noise ratio, such that defects in the filters may be more readily detected. Another problem encountered is a result of the turbulence created within the fog exiting the tested filter caused by the injection of the particles into the gas flow stream while the test is conducted. This turbulent flow disrupts the flow of the particles as they exit the filter, thereby making it more difficult to determine the exact location of an existing defect.

A method for testing a honeycomb particulate trap is desired that improves the signal-to-noise ratio within the above-described testing procedure, while simultaneously allowing for a high-pressure throughput of the associated gas flow stream.

### SUMMARY OF THE INVENTION

According to embodiments described herein, the invention is a method of detecting a defect in a honeycomb body, comprising the steps of providing a honeycomb structure having an inlet face and an outlet face, and providing a gas flow stream at a given flow rate, pressure and particle density to the inlet face of the honeycomb structure, wherein at least a portion of the particles are emitted from the outlet face of the honeycomb structure. The method further comprises varying the flow rate, pressure and/or particle density of the gas flow stream as the test is conducted, providing a particle detection device, and detecting an amount of particles emitted from the outlet face of the honeycomb structure with the particle detection device subsequent to varying the flow rate, pressure and/or particle of the gas flow stream. Thus, defective cells/plugs may be readily identified because locations of leaks/defects appear as bright spots. Preferably, the illuminated particles are also imaged, such as by a digital camera. This image is then compared to an image of the end face to determine which cells include defects.

Advantageously, increasing the relative pressure and flow rate during the precondition of the tested part reduces the relative time required, while reducing the particulate density with the gas flow stream allows the signal-to-noise ratio of the gas stream imaged to be enhanced, thereby making it easier to detect defects. In particular, the reduction of the particulate density results in a reduction in the amount of emitted particles and a subsequently enhanced signal-to-noise ratio, and simultaneously reduces the turbulence within the emitted particle stream allowing a more precise determination of filter defects. Further, the present inventive method may be accomplished by utilizing apparatus currently available, is efficient in implementation, and is particularly well adapted for the proposed purpose. Moreover, the method reduces the time required to precondition a part to be tested and allows the testing to be conducted at a relatively higher pressure, thereby improving throughput.

These and other advantages of the invention will be further understood and appreciated by those skilled in the art by reference to the following written specification, claims and appended drawings.

### BRIEF DESCRIPTION OF THE DRAWINGS

FIG. 1 is a perspective view of a honeycomb filter body including a first end having a plurality of open-ended cell channels;

FIG. 2 is a perspective view of the honeycomb filter body wherein a first subset of cell channels is plugged, and a second subset of channels is open-ended;

FIG. 3 is an end view of the filter body including a second end, wherein the first subset of the cell channels is open-ended and a second subset of cell channels is plugged.

FIG. 4 is a partially schematic view of the apparatus for detecting defects in a honeycomb body according to embodiments of the invention;

FIG. 5 is a cross-sectional side view of the honeycomb filter being tested via a prior art testing method;

FIG. 6 is a graph of gas flow pressure versus time for a preconditioning of the filter body;

FIG. 7 is a graph of particle density versus time for the testing of the filter body; and

FIG. 8 is a cross-sectional side view of the honeycomb filter being tested according to embodiments of the invention.

### DETAILED DESCRIPTION OF THE PREFERRED EMBODIMENTS

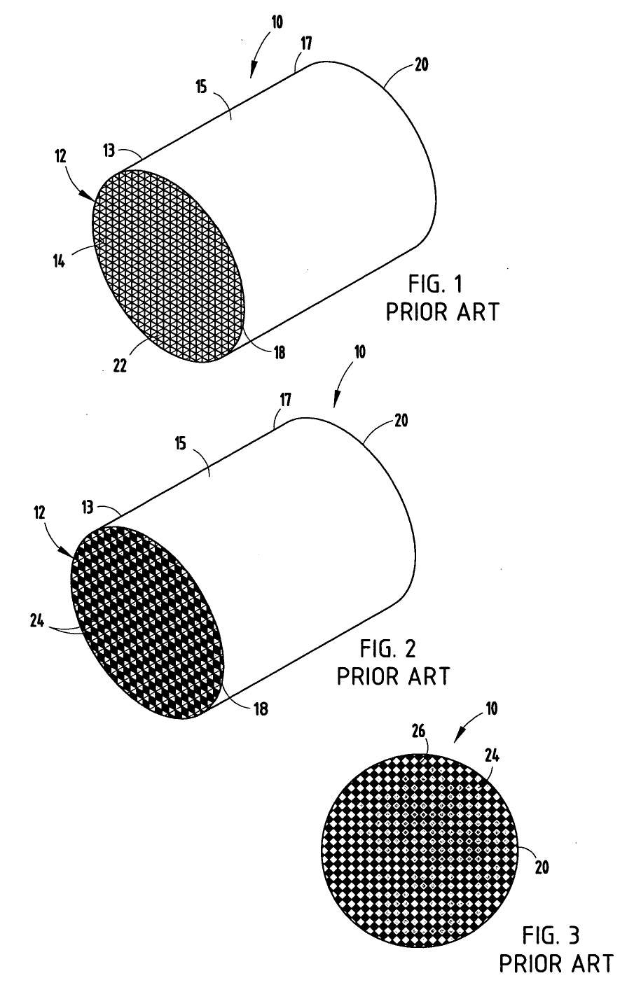

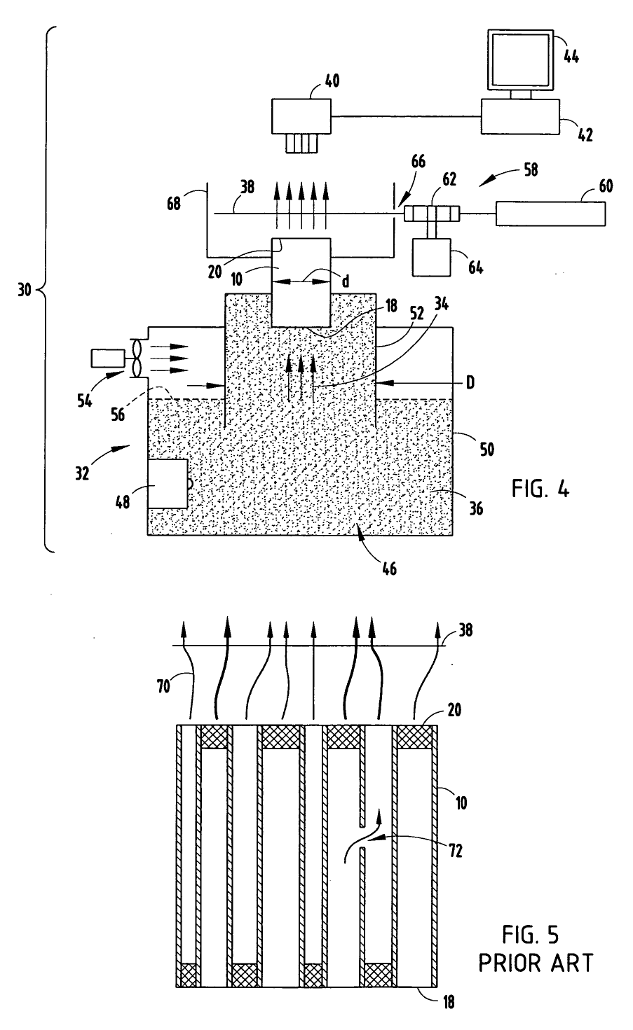

For purposes of description herein, the terms “upper,” “lower,” “right,” “left,” “rear,” “front,” “vertical,” “horizontal,” and derivatives thereof shall relate to the invention as oriented in FIGS. 1 and 4. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

Reference numeral 30 (FIG. 4) generally designates an apparatus employed to accomplish the method embodying the present invention. Specifically, the apparatus device 30 is employable for detecting defects in a honeycomb filter body 10 having cell channels 22 that are selectively end-plugged, such as in a diesel particulate filter. The interior walls 14 and/or plugs of the honeycomb filter body 10 may be porous. The walls 14 and/or plugs are preferably tested for the presence of defects which may affect their performance. For example, the walls may include cracks (such as fissures) or holes which will allow unrestricted flow between adjacent cell channels 22 thereby reducing filtration efficiency or affecting filter integrity. Additionally, the plugs may include defects such as partial fills, holes or cracks, or may even be missing or may be otherwise separated from the cell walls 14.

The inspection testing device or apparatus 30 of the invention includes a particulate source 32 which operates to supply a flow of gas, as represented by directional arrows 34, which contains particulates 36 suspended therein. The gas with suspended particulates 36 is provided to the inlet end face 18 of the filter body 10. The particulates 36 suspended in the gas flow 34 pass into the cell channels 22 and through the porous walls 14 and/or plugs of the filter body 10 and exit out through the outlet end face 20 thereof. After exiting the end face 20, the particulates 36 in the flow are preferably illuminated by a plane of light 38 projected in the vicinity of the filter body 10, preferably parallel to the end face 20 of the filter body 10 and spaced a slight distance therefrom (preferably above). Defects in the plugs and/or walls 14 may then be detected in the filter body 10 by inspection of the interference of the particulates 36 and the plane of light 38.

Preferably, an image indicative of the locations of defective cells is generated, for example by recording an image with an imager 40, such as a camera. The image corresponding to the defective cell locations maybe stored in memory in a computer 42 and/or may also be displayed on a display 44. Defects in the walls 14 and/or plugs show themselves as bright spots in the image above the filter body 10, i.e., at the intersection with the plane 38. Accordingly, their location may be easily correlated with a cell defect location on the filter body 10.

In operation, particulates 36, such as liquid particles, more preferably very fine liquid particles, are formed in a chamber 46 by a particle generator 48 of the particulate source 32. The particulates 36 may be generated by nebulizing or atomizing or otherwise spraying a liquid through a small nozzle. The liquid may be water-based or even glycol-based and, thus, is included in a fog. While water is most preferred, other particulates may be utilized including smoke or other fine suspended particulate matter. The particulates 36 are preferably housed in a housing 50 and provided under pressure through a flow path, which is preferably defined by a pipe 52, between the particulate source 32 and the inlet end face 18 of the filter body 10. The pipe 52 preferably includes a round cross section (however, other cross-sectional shapes are possible, such as square, rectangular, etc.) and is preferably generally axially aligned with the filter body 10. Further, preferably the inner dimension, D, (e.g., diameter) of the pipe 52 at the point where the particulate laden gas is provided to the first end face 18 is larger than a maximum transverse outer dimension, d, of the filter body 10. This feature improves the uniformity of the flow velocity profile, by reducing the effect of boundary layer flow on the flow distribution of the gas, provided across the first end face 18. The provision of pressure, preferably at greater than 30 Pa (relative pressure between the inlet and ambient), is achieved by a fan 54 forcing air into the housing 50. In some embodiments, the pressure is between 30 Pa and 70 Pa. A perforated partition 56 may be employed to minimize variations in pressure within the chamber 46.

An illumination system 58 includes a light source 60 for generating the plane of light 38 adjacent to, and spaced slightly from, the outlet end face 20 of the filter body 10. One example of a light source 60 is a laser, such as a red or green laser. The light source 60 preferably cooperates with optical elements, such as rotating faceted mirrors 62, to convert the light beam to the planar sheet of light 38. Preferably, the mirror 62 is rotated, and includes, for example, 10 facets and produces a plane of light extending through an angle of about 72 degrees. The mirror 62 may be rotated by a motor 64 at greater than 500 rpm, for example. Thus, the illumination system 58 produces a plane of light 38, generally parallel to the end face 20. The number of facets may be varied to extend or contract the angular range to accommodate varying size honeycomb bodies. Optionally, more than one light source may be used to form a uniform, preferably planar, sheet of light 38 across the outlet end face 20 of the filter body 10. For example, U.S. Patent Publication No. 2006/0151926 A1 published Jul. 13, 2006, entitled METHOD AND SYSTEM FOR IDENTIFYING AND REPAIRING DEFECTIVE CELLS IN A PLUGGED HONEYCOMB STRUCTURE, and co-assigned to Corning Incorporated, incorporated herein by reference, describes rings of light sources to produce the plane of light. The light source 60 illuminates particulates emerging from the filter body 10. It should be recognized that other light sources may be used as well, provided a well defined plane of light is formed, for example a UV or IR laser.

Alternatively, it may be desirable to control the spread of the sheet of light 38. In which case, a slot 66 may be formed in the uprights 68 through which the light sheet 38 extends such that a well defined plane of light 38 is projected above the outlet end face 20. The width of the slot 66 on upright 68 is selected to control spread of the sheet of light 30. The uprights control eddy current and minimize air flow disturbances around the filter body 10. Preferably, the distance between the sheet of light 38 and the outlet end face 104 is such that the particulates emerging from the outlet end face 20 still have sufficient momentum to intersect the planar sheet of light 38. Thus, the sheet of light 38 should be as close as possible to the end face 20 without interfering therewith.

After emerging from the filter body 10, the above-described illumination system 58 illuminates the particles in the flow and the imager 40 is preferably used to capture an image of the X-Y position of particles illuminated (the bright spots) due to interference of a light plane 38 with the particles emerging from the outlet end face 20 of the filter body 10. The imager 40 records an image, preferably a digital image, of the interference pattern of the flow emerging from the filter body 10. The image is then processed to detect the presence of, and location of, defective cells/plugs, such that they may be repaired. The processing includes comparing the image pixel-by-pixel against an intensity threshold. Above that pre-selected threshold, the presence of a defect is indicated. The imager 40, such as a camera or camcorder, is positioned above the outlet end face 20 of the filter body 10. The imager 40 captures an image of any illuminated particles flowing out of the end face 20. In particular, the areas where defects are indicated show up as bright spots in the image. In the case of a single defect, the bright spot is a dot above the cell that has the increased particulate fluid flow (due to the defect). Thus, the location of the defect can be immediately identified (by the above processing step) for plugging. The imager 40 may further include an optical system, such as lenses, for focusing on the illuminated region. The imager 40 may include or be attached to the internal processor or computer 42 which processes information collected by the imager 40 into image files and stores the image files in memory. The computer 42 may support various types of image file formats, such as TIFF and JPEG, and may include a video monitor 38 and other peripheral devices necessary for interacting with the system, such as a keyboard and mouse (not shown). These peripheral devices are well known in the art and will not be discussed further. The image files from the imager 40 can be transferred to the computer 42 for further processing. The image files may also be displayed on the video monitor 44.

The imager 40 may be capable of detecting colors other than white light. For example, the imager 40 may be capable of detecting one or more colors selected from, for example, red, blue and green. In the latter case, the sheet of light 38 may have a color that may be suitably detected by the imager, for example red. Since the sheet of light 38 is positioned above the outlet end face 20, particulates emerging at the outlet end face 20 would intersect the sheet of light 38, illuminating the particles at the locations where they intersect with the sheet of light 38.

Cells in the filter body 10 having defects would discharge more particulates and larger particulates than cells not having defects. The size of the spots can provide an indication of the size of the defects in the filter body 10. If the image appears uniform, then there are no defects in the filter body 10. Advantageously, the use of the present inventive process reduces the overall background level of the image thereby improving the signal-to-noise ratio such that the bright spots associated with the defects may be more readily detected as described below. In other words, the threshold may be set lower. Further, more subtle defects may be detected.

As shown in FIG. 5, a flow profile of a prior art system is shown. As can be seen, during the inspection or testing process, the flow lines 70 of the particulates in the gas flow exit the end face 20 and depart from a straight path. Specifically, the turbulence within the gas flow causes the particles to deviate from straight line path rather than being directly above the defective cell 72 thereby making the determination of the location of the defect more difficult. Further, once the filter body 10 is completely saturated, the signal-to-noise ratio worsens, again making defect detection difficult as indicated by thicker arrows.

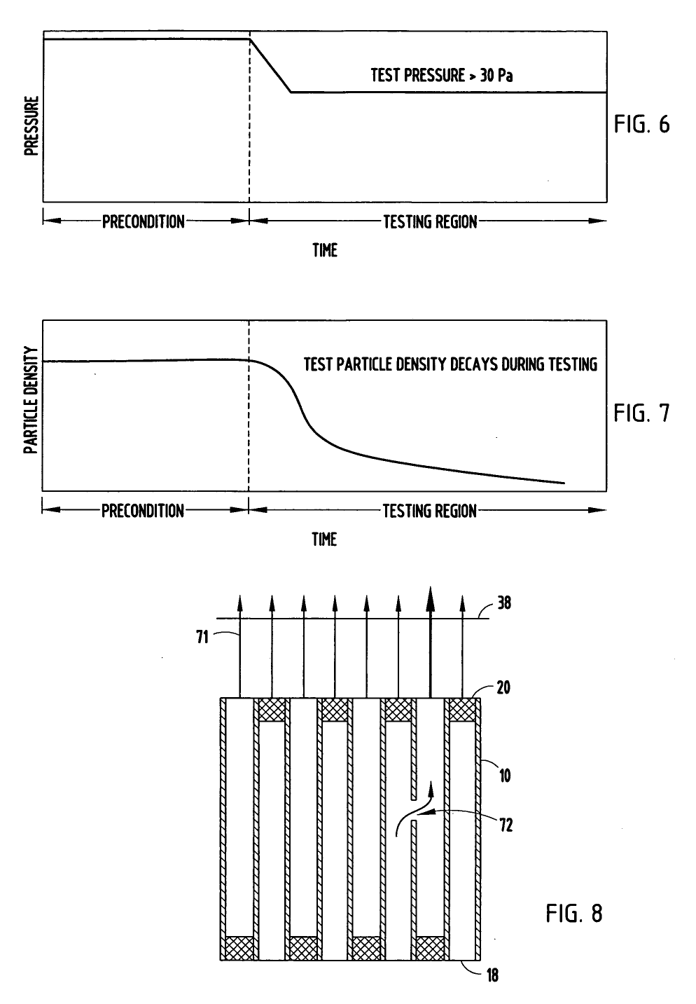

In a preferred embodiment, the particle generator 48 generates particles at a given rate into the housing 50 of the particle source 32. The filter body 10 is preconditioned by providing the gas flow 34 to the filter body 10 at a given flow rate, pressure and particle density, as illustrated in FIG. 6. In order to reduce the amount of time required to precondition the filter body 10, the gas flow 34 is provided at a relatively high flow rate and pressure as compared to the time at which the gas flow 34 is imaged. Preferably, the preconditioning pressure is greater than or equal to 60 Pa while maintaining a contact particle density. Subsequent to preconditioning the filter body 10, the flow rate and pressure is reduced to testing levels, wherein the pressure is preferably greater than or equal to 30 Pa.

In another preferred embodiment, the particle generator 48 is adjusted such that the particle density within the housing 50 is reduced to a second particle density that is less than the first particle density, as best illustrated in FIG. 7, and which is preferably zero such that the particle density decays over time. The gas flow rate created by the fan 54 is preferably maintained at a constant level while the particle density is adjusted, resulting in a reduction to the particle density of the fog passing through the filter body 10 at the same time that the filter body 10 is being saturated, resulting in more fog passes through the filter body 10 as the filter body 10 saturates, thereby offsetting the decreasing particle density within the fog. The result is a relatively constant background noise level over the duration of the test cycle. It is noted that the housing 50 must be large enough to contain enough fog to complete the test before the particle density of the fog is diluted to an undetectable point. Moreover, by reducing the water spray generated by the particle generator to zero, turbulence within the housing 50 is reduced, thereby stabilizing the path of the particles exiting the filter body 10, and as exemplified by straight lines 71 in FIG. 8. By decreasing the turbulence, the exact location of the defect 72 within the filter body 10 becomes more readily detectable.

Advantageously, increasing the relative pressure and flow rate during the precondition of the tested part reduces the relative time required, while reducing the particulate density with the gas flow stream allows the signal-to-noise ratio of the gas stream imaged to be enhanced, thereby making it easier to detect defects. In particular, the reduction of the particulate density results in a reduction in the amount of emitted particles and a subsequently enhanced signal-to-noise ratio, and simultaneously reduces the turbulence within the emitted particle stream allowing a more precise determination of filter defects. Further, the present inventive method may be accomplished by utilizing apparatus currently available, is efficient in implementation, and is particularly well adapted for the proposed purpose. Moreover, the method reduces the time required to precondition a part to be tested and allows the testing to be conducted at a relatively higher pressure, thereby improving throughput.

In the foregoing description, it will be readily appreciated by those skilled in the art, that modifications may be made to the invention without departing from the concepts as disclosed herein, such modifications are to be considered as included in the following claims, unless these claims by their language expressly state otherwise.

The invention claimed is:

1. A method of detecting defects in a honeycomb structure comprising the steps of:
providing a honeycomb structure having an inlet face and an outlet face;
providing a gas flow stream containing particles to the inlet face of the honeycomb structure, wherein the particles are provided at a first density and such that at least a portion of the particles are emitted from the outlet face of the honeycomb structure;
reducing the amount of particles within the gas flow stream to a second density that is less than the first density;
providing a particle detection device; and
detecting an amount of particles emitted from the outlet face of the honeycomb structure with the particle detection device subsequent to reducing the density of the particles from the first density to the second density.

2. The method of claim 1, wherein the step of reducing the amount of particles includes providing the second density as zero.

3. The method of claim 1, wherein the step of providing the gas flow stream comprises providing the gas flow stream under pressure.

4. The method of claim 3, wherein the step of providing the gas flow stream further comprises providing the gas flow stream under a pressure of equal to or greater than 30 Pa.

5. The method of claim 3, wherein the step of proving the gas flow stream further comprises maintaining a constant pressure.

6. The method of claim 1, wherein the step of providing the gas flow stream comprises producing a fog.

7. The method of claim 6, wherein the step of providing the gas flow stream includes comprising the particles of water droplets.

8. The method of claim 1, wherein the detecting step includes providing a light source, and illuminating the particles emitted from the outlet face of the honeycomb structure with a light emitted from the light source.

9. The method of claim 8, wherein the step of providing a light source comprises providing a laser emitting source.

10. A method of detecting defects in a honeycomb structure comprising the steps of:
flowing a gas flow stream containing particles in an inlet face of a honeycomb structure at a first flow rate, a first pressure and a given particle density;
reducing the gas flow stream to a second flow rate that is less than the first flow rate and a second pressure that is less that the first pressure; and
detecting an amount of particles emitted from an outlet face of the honeycomb structure subsequent to reducing the gas flow stream from the first flow rate to the second flow rate and the first pressure to the second pressure.

11. The method of claim 10, wherein first pressure is greater than or equal to about 60 Pa.

12. The method of claim 10, wherein the second pressure is greater than or equal to about 30 Pa.

13. The method of claim 10, wherein the step of flowing the gas flow stream comprises producing a fog.

14. The method of claim 13, wherein the step of flowing the gas flow stream includes comprising the particles of water droplets.

15. The method of claim 10, wherein the detecting step comprises illuminating the particles emitted from the outlet face of the honeycomb structure with a light source.

16. The method of claim 15, wherein the detecting step further comprises providing the light source as including a laser emitting source.

17. A method of detecting defects in a honeycomb structure comprising the steps of:
providing a honeycomb structure having an inlet face and an outlet face;
providing a gas flow stream containing particles to the inlet face of the honeycomb structure, wherein the gas flow stream is provided at a first flow rate and a first pressure, and wherein the particles are provided at a first density and such that at least a portion of the particles are emitted from the outlet face of the honeycomb structure;
reducing the gas flow stream to a second flow rate that is less than the first flow rate, a second pressure that is less that the first pressure, and a second density that is less than the first density;
providing a particle detection device; and
detecting an amount of particles emitted from an outlet face of the honeycomb structure subsequent to reducing the gas flow stream from the first flow rate to the second flow rate, the first pressure to the second pressure, and the first density to the second density.

18. The method of claim 17, wherein the step of reducing the amount of particles includes providing the second density as zero.

19. The method of claim 17, wherein first pressure is greater than or equal to about 60 Pa.

20. The method of claim 17, wherein the second pressure is greater than or equal to about 30 Pa.
